(19) United States
(12) Patent Application Publication
(10) Pub. No.: US 2014/0025724 A1
(43) Pub. Date: Jan. 23, 2014

(54) PERSONAL SAFETY COMMUNICATION SYSTEM

(71) Applicants: Thomas Benjamin Granger, Onchan (IM); Thomas Granger, Leicester (GB)

(72) Inventors: Thomas Benjamin Granger, Onchan (IM); Thomas Granger, Leicester (GB)

(21) Appl. No.: 13/613,617

(22) Filed: Sep. 13, 2012

(30) Foreign Application Priority Data
Jul. 19, 2012 (GB) 1212811.2

(51) Int. Cl. G06F 15/16

(52) U.S. Cl. 709/203

(57) ABSTRACT

A personal safety communications system includes a plurality of user terminals belonging to a plurality of individual users and being interconnected via one or more networks. The system includes an alert management apparatus, the apparatus includes a relationship database storing a set of dependant-guardian relationships among users of said user terminals such that one or more users can be designated as guardians of another user, including the possibility for users to be guardians of one another. The apparatus further includes an alert initiation interface by which a first user having one or more designated guardians can use their user terminal to initiate an alert situation and to indicate their location. The apparatus further includes a guardian response interface and a situation monitoring interface for informing the first user of the identity and location of one or more guardians who have indicated they will attend.

### FIELD

The present invention relates to personal safety communication systems. The invention further relates to access terminals and servers for use in communication systems and to computer program products for use in implementing access terminals and servers.

### BACKGROUND

Modern communications technology, particularly mobile communications devices, offer great potential for improving the safety and sense of safety among individuals and groups such as friends, family and work colleagues. Apart from the ability to make telephone calls and send text messages or emails, there exist a number of applications for smart phone and similar devices that we might broadly call personal safety applications. These seek to automate calling and communication functions, so that help can be sough in an emergency. For example, a young person may find themselves in a situation they feel threatened by their surroundings and need help. This is not necessarily a scenario where they feel that they need the help of the police or indeed where a crime has been committed, but they still want to get out of that situation as soon as possible. They may or may not want assistance from their parents, either. Using location functions such as triangulation and GPS<many mobile devices can know their own location with varying degrees of accuracy. Tracking applications can allow parents, for example, to follow the location of their children, so long as their children carry the mobile device.

It is an aim of the invention to provide the service for users of smart phones and other devices to set up and operate an informal, “social” network of trusted individuals to serve as “guardians” for one another, and to call on them in time of need. While various known personal safety applications have attempted this, they all fail in some respect to meet the needs of users, and to promote adequate take up among a “critical mass” of friends, family and colleagues. Known systems which require logging on to a website to find a person's location are not necessarily practical, particularly if one has logged on at a fixed terminal. Applications that reveal a person's location without asking are regarded as an invasion of privacy, and friends will be reluctant to join.

### SUMMARY

Various embodiments of the present invention are provided to address one or more of the drawbacks of the aforementioned prior art.

According to a first aspect of the invention, there is provided a personal safety communications system comprising a plurality of user terminals belonging to a plurality of individual users and being interconnected via one or more networks, the system including the user terminals including an alert management apparatus, the alert management apparatus comprising:
a relationship database storing a set of dependant-guardian relationships among users of said user terminals such that one or more users can be designated as guardians of another user, including the possibility for users to be guardians of one another;
an alert initiation interface by which a first user having one or more designated guardians can use their user terminal to initiate an alert situation and to indicate their location;
a guardian response interface responsive to initiation of said alert situation for providing to users who are guardians of the user via their user terminals, notification of the alert including an indication of the location of the first user and for receiving from the guardian an indication whether they will attend or not attend to assist the first user and in the event that they will attend for receiving from the guardian's user terminal an indication of the guardian's location; and
a situation monitoring interface for informing the first user of the identity and location of one or more guardians who have indicated they will attend.

In some embodiments, said alert management apparatus is formed by said user terminals operating in conjunction with one or more server devices connected to the network, the server device(s) being operable for the exchange of data messages with each user terminal. Said relationship database may be maintained by the server, wherein the user terminal of the first user is arranged to send an alert initiation message to said server, and the server is arranged to send a guardian response invitation to guardians who are identified in the relationship database as guardians of the first user. The exchange of data messages communication between said user terminals and server may be independent of email and SMS applications to which said user terminals and/or the server may also have access.

In some embodiments said situation monitoring interface includes a map display showing the relative locations of the dependant and one or more attending guardians. The situation monitoring interface may be arranged to update said map display automatically as the locations of the users change over time.

The situation monitoring interface may additionally include a message entry and display function by which users can submit messages for one another to read without switching to another application. Said message display may be viewable simultaneously with said map display and display a combination of messages associated with the alert situation, the messages including messages containing content generated explicitly by other users and messages generated automatically by the alert management apparatus in response to events in the operation of the alert management apparatus and the various interfaces thereof.

The alert management apparatus may include provides participating users with an alert terminating interface and imposes an alert terminating protocol, and by means of which an alert can be terminated only in the event that alert termination messages are received from a predetermined combination of user terminals, not from the dependant's terminal alone.

Functions of said alert management apparatus to be performed by said user terminals may be implemented by installing a personal safety application on a multi-purpose user terminal device, the user terminal device comprising a programmable mobile communication device having an operating system, user interface functions, communication functions and optionally geolocation functions.

The system may further comprise a relationship management interface by which a user can invite one or more other users to become their guardian and/or dependant, the relationship management system updating said database with a new relationship in response to a recipient accepting such an invitation. In one implementation, said alert management apparatus is implemented in part by a personal safety application installed on a user terminal device, and for inviting a user to become guardian or dependant who has not yet installed said personal safety application, the relationship management interface is arranged to issue an invitation to download and install the application using an email or SMS applications to which said user terminal device has access.

In some embodiments, one or more other users are designated rangers, the alert management apparatus including a facility to invite such a ranger as a guardian in response to an alert from the first user with a location corresponding to a ranger's geographic area.

The relationship database may be configured so that for at least a subset of users, more than one set of guardians can be designated, and said alert initiation interface may be arranged to identify directly or indirectly which set of guardians should be invited in response to a current alert initiation message.

According to a second aspect of the invention, there is provided a user terminal configured to implement the user terminal functions of the alert management system in a personal safety communication system as described above.

According to a third aspect of the invention, there is provided a computer program product for configuring a programmable user terminal device to implement the user terminal functions of the alert management apparatus in a personal safety communication system as described above.

According to a fourth aspect of the invention, there is provided a server device configured to perform server functions of the alert management apparatus in a personal safety communication system as described above.

According to a fifth aspect of the invention, there is provided a computer program product for configuring a programmable computer server to implement server functions the alert management apparatus in a personal safety communication system as described above.

The above and other aspects, features and advantages of the invention will be understood by the skilled reader from a consideration of the following detailed description of exemplary embodiments.

### BRIEF DESCRIPTION OF THE DRAWINGS

Embodiments of the invention will now be described, by way of example only, with reference to the accompanying schematic drawings in which corresponding reference symbols indicate corresponding parts.

FIG. 1 is a schematic view of a personal safety communication system according to an embodiment of the present invention.

FIG. 2 shows a registration screen of an access terminal in the system of FIG. 1.

FIG. 3 shows a “Home” screen of the access terminal in the system of FIG. 1.

FIG. 4 shows a “Network” screen of the access terminal in the system of FIG. 1.

FIG. 5 shows a “My Details” screen of the access terminal in the system of FIG. 1.

FIG. 6 shows an “Invites” screen of the access terminal in the system of FIG. 1.

FIG. 7 shows a “Contacts” screen of the access terminal in the system of FIG. 1.

FIG. 8 shows a “Contact” screen of the access terminal in the system of FIG. 1.

FIG. 9 shows a “Panic” screen of the access terminal in the system of FIG. 1.

FIG. 10a is a first view of a “Monitoring” screen of the access terminal of a user acting as a “guardian” in the system of FIG. 1, in.

FIG. 10b is an exemplary map displayed on the map section of the “Monitoring” screen of the access terminal of a user acting as a “dependant” in the system of FIG. 1.

FIG. 10c is a further exemplary map displayed on the map section of the “Monitoring” screen of the access terminal of the dependant.

FIG. 11a is another view of the “Monitoring” screen of the access terminal of the guardian in the system of FIG. 1.

FIG. 11b is another view of the “Monitoring” screen of the access terminal of the dependant in the system of FIG. 1.

FIG. 12 is a “Panic List” screen of the access terminal of the guardian.

FIG. 13 is an exemplary enlarged view of navigation tabs present in all screens of the application.

FIG. 14 is a block schematic diagram of the server 104 in the communication system of FIGS. 1 to 13b.

FIG. 15 is a schematic block diagram of an access terminal in the system of FIG. 1.

FIG. 16 is an exemplary call-flow diagram showing the sequence of communications associated with handling a panic alert in the system of FIGS. 1 to 15.

FIG. 17 is an exemplary call-flow diagram showing the sequence of communications associated with handling a panic alert in the system of FIGS. 1 to 15 having a user designated as “ranger”.

FIG. 18 is an exemplary call-flow diagram showing the sequence of communications associated with handling a request message in the system of FIGS. 1 to 15 having an optional “Find my Child” module according to an embodiment of the present invention.

FIG. 19 shows a modified “Home” screen showing optional features integrated in the system of FIGS. 1-15.

### DETAILED DESCRIPTION OF EXEMPLARY EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiments may be practiced without these specific details. In other instances, well-known structures and devices are shown in block diagram form in order to facilitate describing one or more embodiments.

Furthermore, various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be implemented in a variety of hardware devices, a cellular telephone, a cordless telephone, a Session Initiation Protocol (SIP) phone, a wireless local loop (WLL) station, a personal digital assistant (PDA), a handheld device having wired or wireless connection capability, a TV, computing device, or other processing device connected to a wireless modem.

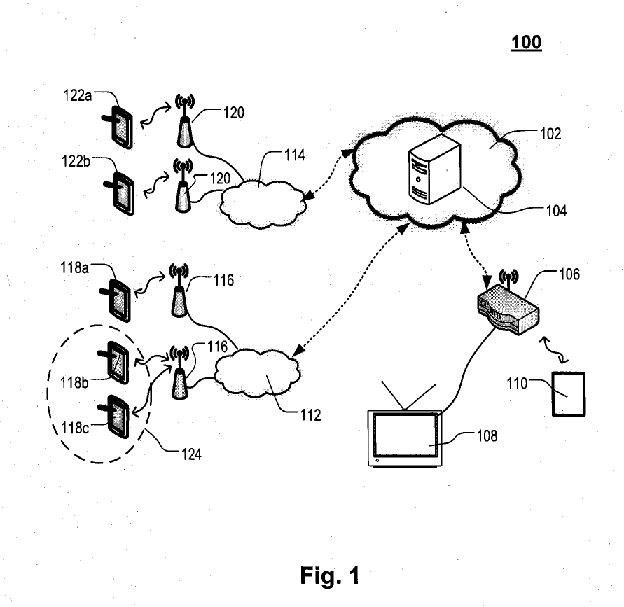

FIG. 1 is a schematic view of a personal safety communication system 100 according to an embodiment of the present invention. Communication system 100 includes a personal safety system server 104 and access terminals 108, 110, 118a-118c and 122a-122b. For example, according to FIG. 1 an access terminal may be any of mobile phones 118a-118c and 122a-122b, a TV 108 or a mobile computing device like a personal laptop 110. Mobile phones 118a-118c and 112a-112b can be a smart phone running an operating system provided by, for example, Apple iOS® or Google Android®, Microsoft Windows Mobile®, Research In Motion Blackberry OS® and an operation system compatible with Amazon® phone. TV 108 can be a so-called smart TV running an operating system and installing applications as desired by a user. More detail of the exemplary access terminals and server will be provided below.

Each access terminal of communication system 100 is provided with a personal safety module, typically implemented by computer program installed on general-purpose hardware to communicate with a corresponding personal safety module of other access terminals through safety system server 104. For example, server 104 can communicate with access terminals through the internet 102. Mobile phones 118a-118c and 112a-112b can communicate with base stations 116 and 120 respectively. Base stations 116 and 120 may connect to different mobile networks 112 and 114 and provide the communication between the mobiles phones and server 104. TV 108 and laptop 110 may connect to the internet 102 through a Wi-Fi device 106.

The personal safety system is based on users establishing their own social networks of relationships, typically among friends, colleagues and family. In a network for the safety of the one user, that user may be designated the “dependant”, while one or more other users are designated “guardians” to that dependant. Relationships are not necessarily reciprocal: two peers may be guardians to one another; a child may not be expected to serve a guardian for their parent. The network of guardians for each dependant is built and modified entirely under the control of the users, according to the levels of trusted capabilities best known to themselves. Exceptions or restrictions to this principle can be created for minors or vulnerable adults, as discussed below, without departing from the basic concept.

To have access to the personal safety functions of the system, a user of an access terminal can simply install computer program as an application in their existing device, for it to serve as the access terminal. There is no requirement for the access terminal to be implemented in this way, but of course take-up of the system will be greater if users do not have to purchase, carry and maintain a separate unit.

Before describing the personal safety communication system in operation, we will describe the various functions and steps for registering a user and establishing a network of dependants and guardians.

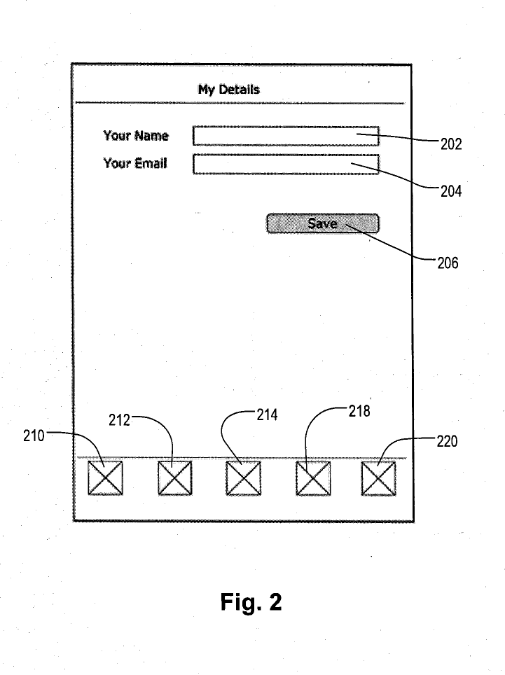

As shown in FIG. 2, when the application is first opened after installation, an exemplary screen of “My Details” of a user pops up to allow the user to register with server 104. The screen has fields 202 and 204 for the information of a name and an email address of the user. A button 206 can trigger to save the name and email address of the user to server 104. According to FIG. 2, there are exemplary tabs 210-220 at the bottom of the screen. Each of tabs 210-220 and other functions of the application are explained below. Of course, the particular user interface is a matter of design choice and the example presented here is not intended to be limiting in any way. The user interface in the example is based on a touch screen device, but of course other input and output device may be used.

Home Screen

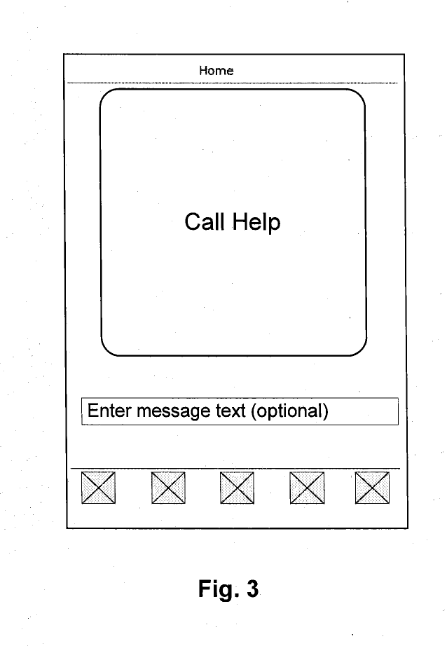

FIG. 3 is an exemplary diagram of a “Home” screen of the application according to an embodiment of the present invention. The “Home” screen is the first screen that displays when the application is opened by a registered user.

The Home screen contains a panic button (here labelled “Call Help”), for use in calling for assistance. Pressing this button initiates a panic alert and takes the user to a Panic screen as described below. A field is provided for the user to enter a message describing the nature of the incident, if they wish.

If a user has opened the application with no other users nominated as guardians, then the panic button does not show. The application can show a text message like “You currently have no Guardians, please invite a Guardian”, with an “Invite” button that can take the user to an “Invite” screen as described below.

Network Screen

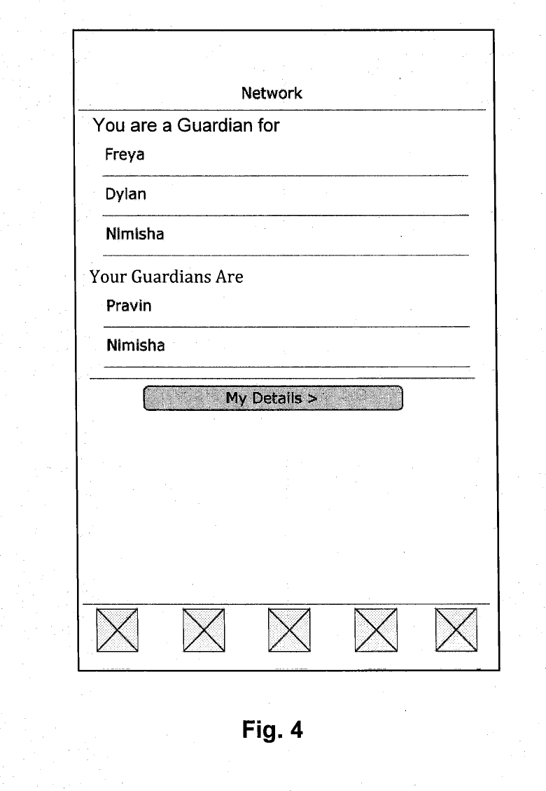

FIG. 4 is an exemplary diagram of a “Network” screen of the application according to an embodiment of the present invention. The Network screen can display all the user's dependants and guardians. The network screen includes the following sections:
List of dependants (“You are a Guardian For”)

The list of dependants of the user means that the user is a guardian to the other users listed as dependants. If the user has no dependants then this section will display a message suggesting they invite some dependants.
List of guardians (“Your Guardians Are”)

The list of guardians of the user means that the user is a dependant to each of the users listed as guardians. If the user has no guardians then this section will display a message suggesting they invite some guardians.
My Details

By clicking this button, the user can be taken to a My Details screen for the user to change the name and email address of the user. Once the user has changed the name and address through My Details screen, the updated name and address information is automatically updated to server 104. Server 104 can then send the updated name and address of the user to other users of a social network of the user.

Optionally, the Network screen may have one or more buttons of a social network site like Facebook® or Twitter® which allow a user to post to the social network site a message that they have downloaded the application.

My Details Screen

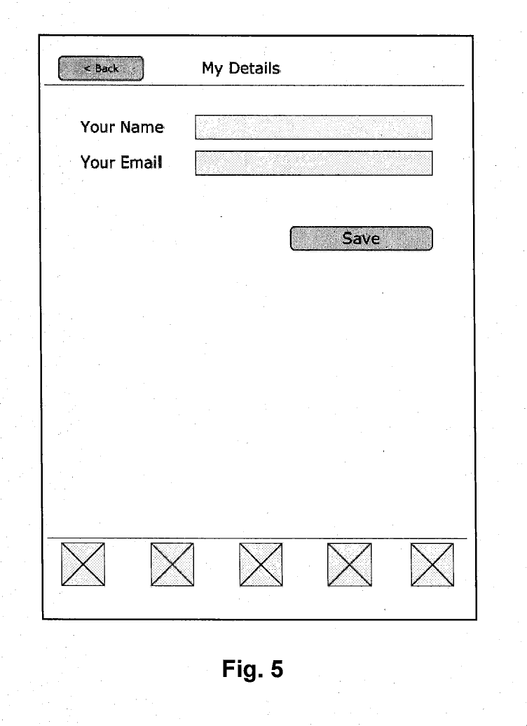

FIG. 5 is an exemplary diagram of a “My Details” screen of the access terminal in the system of FIG. 1. The My Details screen can be accessible from the Network screen, for example, and/or from the Home screen. The My Details screen includes the following sections:
Back

This button can take the user back to the Network screen or Home screen as the case may be.

If the user has opened the application for the first time, the My Details screen can display without the Back button for the user to register.
Name

This is a field for the user to enter a name during registration, or to change a registered name after successful registration.
Email

This is a field for the user to enter an email address during registration, or to change a registered email address after successful registration.
Save

This will save the information entered in the My Details screen to server 104.

Invites Screen

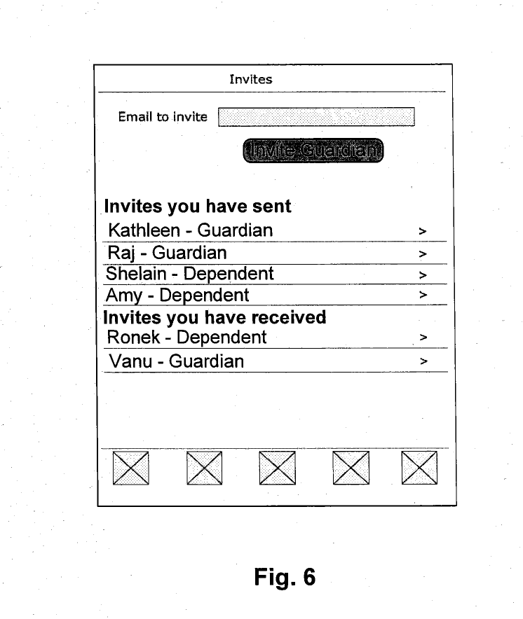

FIG. 6 is an exemplary diagram of an “Invites” screen of the application according to an embodiment of the present invention. The Invites screen can display all the invites (invitations) sent or received for the user. The Invites screen includes the following sections:
Invite Guardian

This dialogue allows the user to enter an email address of a recipient and invite that recipient to be a guardian for the user by clicking an appropriate button as shown in FIG. 6. The function of this button may be read as “Invite as your Guardian”.

The user may have a list of contacts already stored in their access terminal (mobile phone etc). The user can invite someone that is in the user's contact list. If the “Via Contacts” button is clicked, then the user can be taken to a Contacts screen as described below. The “Via Contacts” button may be replaced with a small button showing an “Address Book” symbol.

In one example, a user A can simply invite a user B to a guardian of user A, after user B has invited user A to be a guardian of user B and user A has then accepted the invitation. An effect of this arrangement is that user A does not need to enter any details in order to invite user B to be a guardian and can thus reduce any mistakes and time cost in sending an invitation to user B. The establishment of an informal, social network of guardians based on reciprocal relationships is facilitated, as distinct from some formal and unidirectional parent-child or carer-client relationship.
Invites you have sent

This can list the persons who have been invited by the user to be a guardian or dependant of the user.

If a user clicks a person on this list, then a screen displays that allows the user to cancel the invitation.
Invites you have received

This can list the persons who have invited the user to be a guardian or dependant of them. If the recipient does not yet have a compatible personal safety application installed, they may firstly receive a link by email, inviting them to install the application.

If a user clicks a person on this list, then a screen displays that allows the user to accept or reject the invitation.

Contacts Screen

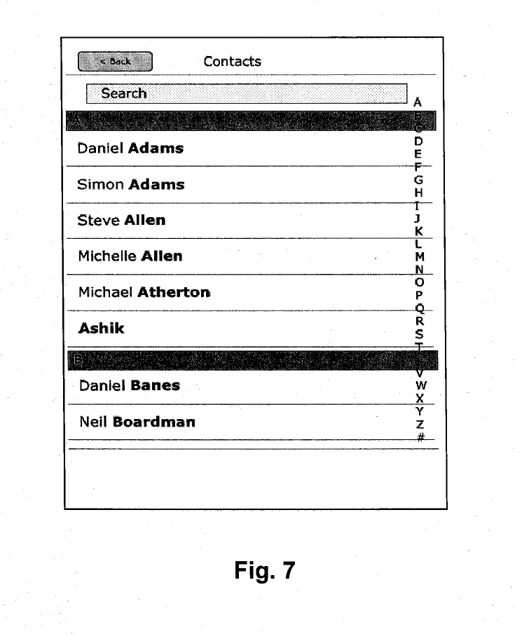

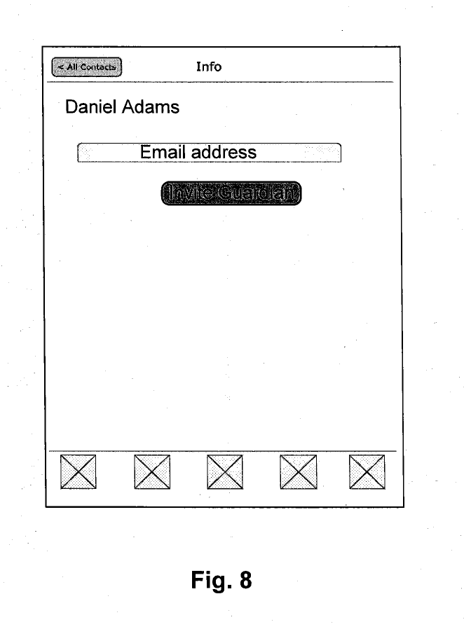

FIG. 7 is an exemplary diagram of a “Contacts” screen of the application according to an embodiment of the present invention. The Contacts screen shows the list of user's contacts from the access terminal. If the user selects a contact from the list to invite, the user is then taken to a Contact screen to invite the contact. An exemplary Contact screen is shown in FIG. 8.

Contact Screen

FIG. 8 is an exemplary diagram of a “Contact” screen of the application according to an embodiment of the present invention.

The Contact screen will display a contact the user has selected from their contacts list. As shown in FIG. 8, the user can invite the contact person to be a dependant of the user or a guardian of the user by selecting an appropriate invite button. In another embodiment, there is no option to invite dependants, only guardians.

The Contact screen may be designed to be identical to the contact screen of a contacts application in the user's smart phone or other user terminal device. In one example, after selecting a contact, the user may only be able to see the email addresses associated with that contact. If no email is available, a message can be used to inform the user of that. After the user taps an desired email address, the email address can be automatically put into the “Email to invite” field in the Invites screen as described above.

Panic Screen

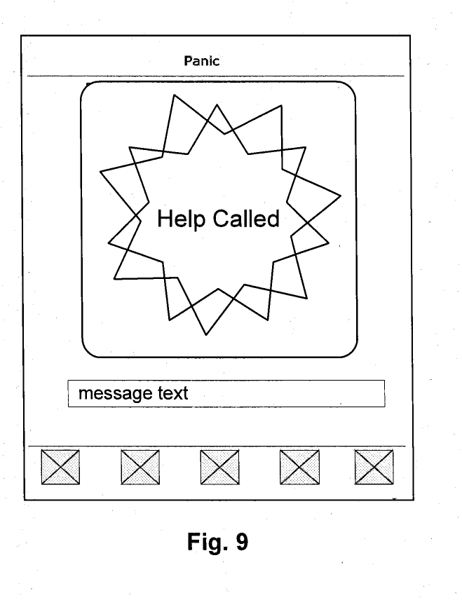

FIG. 9 is an exemplary diagram of the “Panic” screen of the application according to an embodiment of the present invention. The Home screen allows the user of an access terminal as a dependant to click the panic button (“Call Help”) to initiate a panic alert. The user can optionally enter a message if they wish to do so, giving. When the dependant clicks the panic button, the display changes to the Panic screen to provide visual confirmation. The dependant can after some delay is taken to a Monitoring screen (described below).

The protocols by which a panic alert incident can be ended are very important for the confidence of users. For example, to allow the incident to cancelled by a simple action on the dependant's access terminal does not offer protection against abuse by third parties. Therefore more complex protocols may be imposed by the system. In a first example protocol, the incident may be ended mutually by two or more parties using their terminals to confirm that the alert is over, one of whom must be the user who has triggered the alert. This is further described in the below exemplary embodiments. In another example, the protocol may require two users to confirm that the alert is over, in addition to the user who triggered the alert. That protocol may allow the alert to be ended by two users (dependant plus one guardian) as an exception, if only one guardian is attending. In addition, the protocol for ending alerts may include a timeout function. For example a panic alert may be closed automatically after 24 hours.

Monitoring Screen

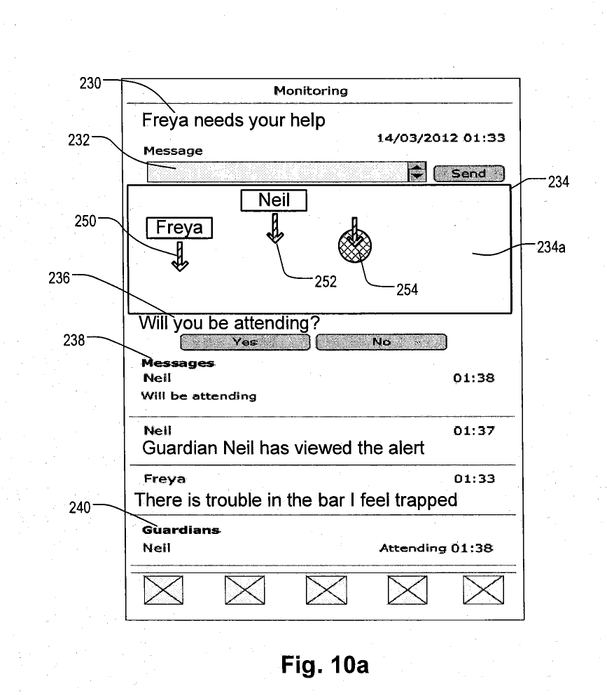

FIG. 10a is an exemplary diagram of a “Monitoring” screen of the application according to an embodiment of the present invention. The Monitoring screen is provided for guardians and the dependant to be able to monitor all aspects of one or more panic alarms incidents in a single view. The information shown to each user by the monitoring screen is different. In particular, information is selected not only to reduce clutter but also to respect privacy of the individuals, should they wish it. The monitoring screen includes the following sections:
Dependant section

A dependant section 230 shows the name of the dependant and the date/time that a panic was activated.
Message box

A message box 232 is provided for the dependant or guardians to add messages as an incident progresses. Messages are relayed via the server 104, by default, not via the existing email or short message service (SMS) applications. However the application may resort to SMS function of the user terminal device where the data connection to server 104 is not found or not reliable.
Map

A map section 234 can display a map 234a indicating the positions of the dependant and guardians that have responded. In one example, the position of the dependant and guardians are shown as pins or dots on the map. Examples of the map display will be described later.
Will you be attending?

This only shows to a guardian when the guardian views the screen, as indicated in FIG. 10a as 236. Also, once the guardian has selected a response it will not show again. A decision of the guardian is then added to the message list. If a guardian has elected not to attend incident, the position of the guardian is neither sent to server 104 nor displayed on the Monitoring screen of other users' access terminals. An effect of this is that the privacy of a user using the application can be protected. This in turn promotes growth of the network by reducing privacy concerns that might otherwise discourage take-up.
Messages

A section 238 of messages displays all messages added by the dependant and guardians. Any message entered by the dependant when they raised the panic alert will be displayed. A message will be added automatically when a guardian first views the alert and when they make the decision to attend or not to attend.

There are options for a guardian to decide whether to attend the incident or to decline to attend. In one example, a guardian can decline to attend but want to be informed of the rescue progress. Message section 238 provides such a guardian to be informed of the rescue progress, although the guardian is not attending the incident.
Guardians

A section 240 of guardians lists all of the guardians of a dependant who have decided to attend.

Each of the sections above can be made re-sizable and/or collapsible to free up screen space for other sections. List of messages, guardians will be scrollable.

A particular feature of the implementation described here is that positions of users are only revealed to other users when they give consent by their actions in each situation. Thus for example, the position of a dependant may only be displayed after the dependant sends an alert message which is relayed to a guardian. Similarly, the position of a guardian is only revealed to the dependant (and optionally to other guardians), after the guardian confirms to attend to help the dependant in this particular alert situation.

To illustrate these situations an example of an alert situation will be described, by reference to FIGS. 10a-10c. A user acting as dependant in this illustration is called Freya. Another user acting as guardian is called Neil. Anther guardian is called Vanu.

FIG. 10a shows a Monitoring screen of the application as it might be displayed to user Vanu. In FIG. 10a an exemplary map 234a is shown on the map section 234. After a dependant sends an alert message to a list of guardians on the access terminal of the dependant through server 104, the position 250 of the dependant Freya is displayed on the monitoring screen of the access terminal of a guardian Vanu. Also displayed in this example is the position 252 of any guardians who have already indicated they will attend (here Neil). Also shown is the position 254 of user Vanu himself. A Yes/No dialogue 236 asking “Will you be attending?” is displayed to the guardian Vanu to let him confirm whether he is going to attend the incident. The other guardians also see this question. In the illustrated situation, there is a message saying Neil has already confirmed he will be attending.

In one embodiment of the present invention, the position of the user of an access terminal is shown to that user as a pin with a circle of uncertainty. The position of other users associated to the user of the access terminal is shown as a flag or pin (the uncertainty is not known). A text label by each pin displays the name of the other user. The text label may not be shown until the user taps the pin. This form of display makes it easy and efficient for a user of the access terminal to locate the positions of themselves and another user on the map.

Before a positive confirmation from any guardian is sent back to the server (or after a negative confirmation from the guardian) and relayed to the access terminal of dependant Freya, a map 234b is shown on the map section 234 of the monitoring screen of the dependant Freya which shows only her own position, as seen in FIG. 10b. Updates as to which guardians have viewed the message are provided, but not their positions. This is an optional feature, and may be made subject of user preference for each guardian. Again, maximising options for users to guard their own privacy reduces the number of reasons why they might not join a network.

If a guardian decides to attend to help the dependant, the guardian can confirm the attendance to the dependant through section 236 of the monitoring screen shown in FIG. 10a. After a positive confirmation from a guardian, the location of the guardian and a message (like “Neil is attending”) will appear on the dependant's map display. With one or more positive confirmations from guardians, the Monitoring screen of the dependant's access terminal shows a map 234c as in FIG. 10c. Here, the positions 252 and 254 of the attending guardians Neil and Vanu display to the dependant Freya with a text label (when tapped) indicating the name of each attending guardian. Guardians not attending do not reveal their location.

Maps similar to map 234c of FIG. 10c will be shown on the Monitoring screen of each attending guardian's access terminal. However, if assuming Neil is one of the attending guardian users, on the Monitoring screen of Neil's access terminal the position of Neil is shown as a circle and pin, and the positions of Freya and Vanu are shown as pins. In this way, each participant in the incident can see a full picture and act accordingly. If a guardian user knows he is closest to the dependent user, the guardian user can focus on arriving there. If a guardian user knows that he is furthest, that guardian user can focus on doing some different to help the situation from distance (such as guiding a driver who is close).

The dependant Freya can thus see who is attending and how far away they are. Users can message one another at all times via the application, without moving away to other applications such as text or email. Positions of the guardians and the dependant, if moving, can be updated on each other's displays periodically or updated on demand by for example clicking a Refresh button on the screen (not shown). Such an update may occur when a message is entered or when the position of a user has moved around.

As mentioned above, the system implements certain protocols to determine when an alert incident is ended. Each user (dependant and attending guardian) may have a button displayed on their Monitoring screen, allowing them to indicate that the dependant is safe and the alert can be ended. When the identity and number of users pressing this button satisfies the protocol, the system determines that the alert is ended and updates the database and sends update messages to the user terminals and to a log for the incident.

Optionally, the system may use the updating geolocation data for the users as an element of the protocol. For example, a guardian may be invited to say the dependant is safe only when the location data indicates they are within a close proximity. Whether such protocols are practical depends on the quality (accuracy and reliability) of the location information from GPS or other systems. In practice, such data is not always precise or reliably present. Protocols based only on human inputs may thus be preferred.

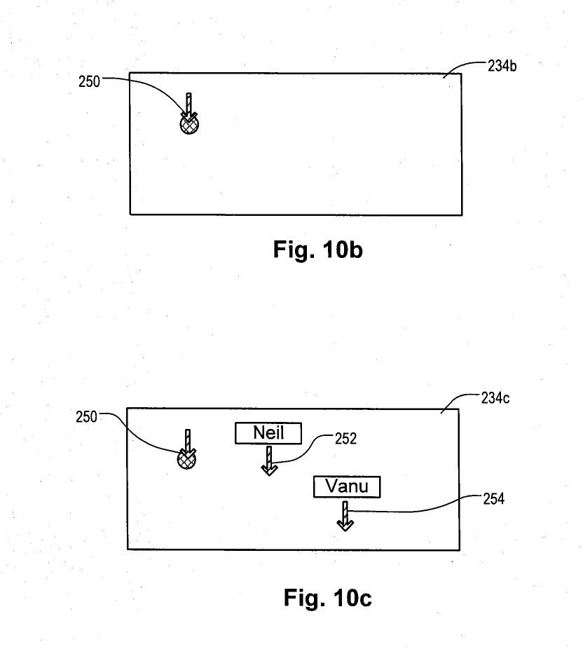

As an example, FIG. 11a illustrates the “Monitoring” screen as displayed to the guardian Neil. The application in this embodiment automatically presents a dialog “Is Freya Safe” to allow the guardian to confirm whether the dependent user Freya is safe. This dialogue may be presented continually, or only when the server detects that the two users are close enough to be considered at the same location. As before, the position of the dependant is displayed as a pin with a text label showing the name of the dependant, and the position of the guardian is displayed as a spot.

A similar Monitoring screen, as shown in FIG. 11b, is displayed to the dependant Freya to allow the dependant to confirm whether she is safe. On her map the position of the guardian is displayed as a pin with a text label showing the name of the guardian, and her own position is displayed as a pin and circle.

The Monitoring screens of FIGS. 11a and 11b appear when server 104 determines that the guardian Neil has reached the dependent user Freya according to the positions 270 and 272 of the dependent user and the guardian. Only when both users confirm Freya is safe does the server consider that the panic situation is resolved and the alert is cancelled. The other guardians are informed.

Panic List Screen

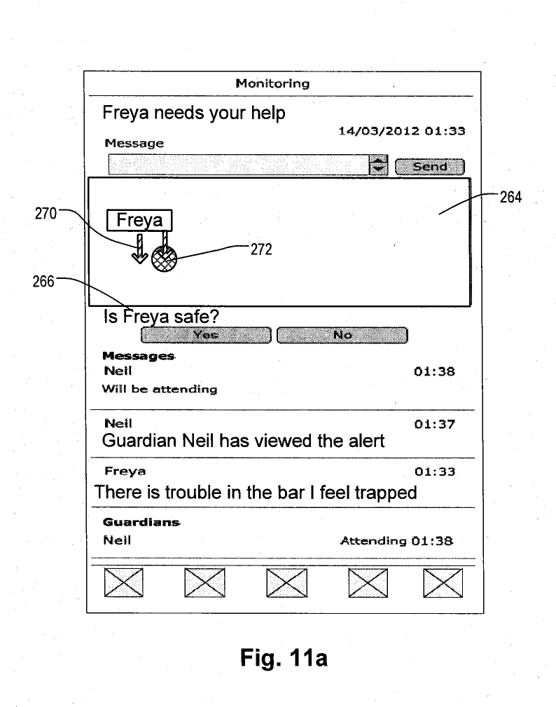

FIG. 12 is an exemplary diagram of a “Panic List” screen of the of the access terminal in the system of FIG. 1. The Panic List screen only displays if a guardian has more than one panic alerts that have been activated at the current time. The Panic List screen shows a list of dependants each of who has activated an alert. When an item on the list is clicked by the user, the user is taken to the Monitoring screen for that alert. Optionally, the last message from each alert situation can be shown on this screen.

Tabs

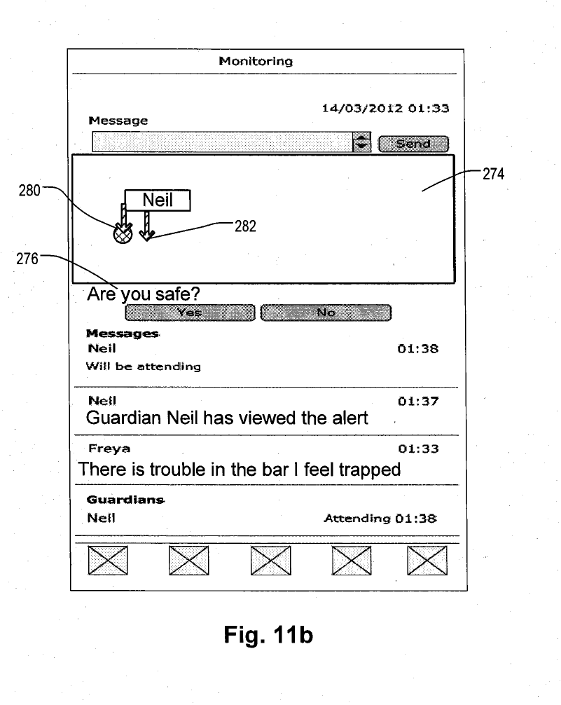

FIG. 13 is an enlarged view of tabs present in most screens of the application according to an embodiment of the present invention. The tabs HM-MON are simply buttons which are placed along the bottom or top of the display allow a user to navigate between sections and screens of the application. The tabs may be designed to be dynamic and the number of the tabs can change, depending on whether the user is a dependant or a guardian and the situation in which the user is at that time. The tabs in this illustration are:
Home

A home tab is shown as HM in FIG. 12. This tab always displays and can take the user to the Home screen where a panic alert can be initiated.
Network

A network tab is shown as a NW in FIG. 12. This tab can take the user to the Network screen.
Invites

An invites tab is shown as IVT in FIG. 12. This tab always displays and can take the user to the Invites list screen.
Panic

A panic tab is shown as PAN in FIG. 12. This tab to send a panic alert only shows if the user has a guardian.
Monitoring

A monitoring tab is shown as MON in FIG. 12. This tab only shows if a panic alert has been activated. It can show to a dependant who has activated an alert, and to the guardians of any dependant who has activated the alert.

Pressing this tab leads to the Monitoring screen. If more than one panic alerts have been activated then the user as a guardian is taken to the Panic List screen.

Referring again to FIG. 1, the communication system 100 can operate across different mobile networks, even where the user of an access terminal is not a subscriber to a local network, since different network operators allow the data and signal transmission related to the application of the communication system 100. For example, networks 112 and 114 may belong to different mobile telephone network operators, but have in common that their terminals are connected to the internet for data communication. As a result, the messages from a dependant can be relayed to all guardians as quickly and efficiently as possible.

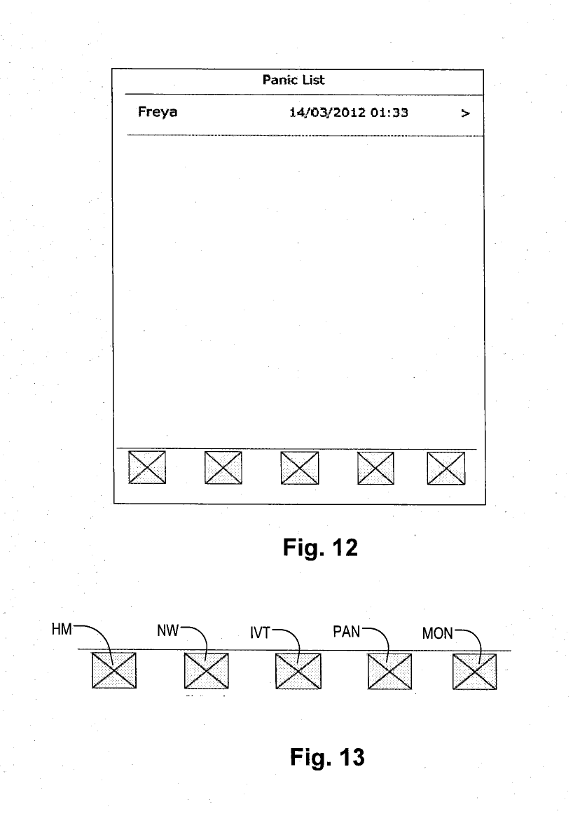

FIG. 14 is a block schematic diagram of the server 104 in one implementation of the communication system of FIGS. 1 to 13. In terms of computer hardware, typical elements of a server are provided, namely user I/O systems UIO, network interfaces NIF and storage STO. Processors and memory (RAM, ROM etc) are provided but not illustrated separately. Suitable operating systems are implemented in firmware and software so that a personal safety system server application SVRAPP can run on the hardware. The server application communicates with an operator via user I/O systems UIO and with access terminals AT (service users/subscribers) via network interface NIF. The operator can alternatively access the system through an access terminal on the network, of course.

Key modules of the server application are a registration manager REGMGR and a panic incident manager PANMGR. The panic incident manager receives panic alert messages and maintains a register of panic incidents PINC-1, PINC-2 etc., for as long as each incident is live. Of course an archive of past incidents may also be maintained. For each incident, the register entry contains details of the user (dependant) instigating the alert, links to the IDs of guardians together with their attending/non-attending status, geolocation information for the users involved, messages exchanged by users to and from the server, and any other data necessary for the described functioning of the application.

Registration manager maintains a database of user data and handles the user registration processes, invitations and the like. For each user, a data record is stored in a database within storage STO. In each record, just for the sake of illustration, there may be contained identification fields USRID which contain personal details such as name, email address, mobile number and the like. Configuration field CFG are stores data about the user, for example whether they are a minor, whether they subscribe to enhanced services, mobile software updates etc. Fields GRDLST and DEPLST contain lists indicating which other users are designated as guardians and dependants of the current user.

The division of the server application into different modules is a matter of design choice and the division here is schematic and for the purposes of illustration only.

The application can be subdivided into more or fewer modules. The modules can be implemented as separate applications, if desired. A further module or modules SYSADMIN may be provided to perform administrative and housekeeping functions necessary for the secure and reliable operation of the application. Duplicate modules and hardware can be provided for multitasking and/or redundancy in case of failures. Multiple servers can be provided to increase capacity and/or redundancy. Different servers can be provided in different territories, with the option to link databases automatically or at user request, when users roam from one territory or another.

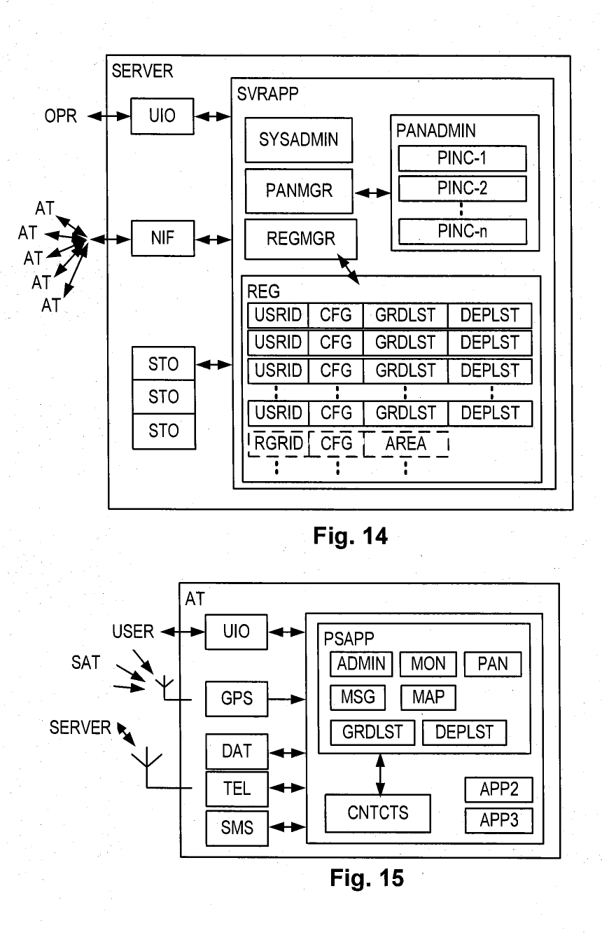

FIG. 15 is a schematic block diagram of one implementation of an access terminal in the system of FIG. 1. In the example illustrated, the terminal is a mobile phone handset with or tablet with cellular data and GPS capability. Other types of hardware can be used to implement fixed and/or mobile access terminals. Access may be via wi-fi, when in range, or wired network connections. A fixed access terminal such as a smart TV or desktop PC may be useful for a ‘dependant’ user issuing alerts from a base location, and for guardians receiving alerts and monitoring passively. However, most of the time, the dependant and users attending as guardians may be expected to use mobile terminal equipment such as smart phones and tablet devices with cellular data connections and GPS. Where a terminal lacks GPS functions, it may still be able to provide geolocation data by other means. The source of geolocation data can be selected by additional configuration screens in the application, as the need arises.

In terms of computer hardware, typical elements of a mobile access terminal are provided, namely user I/O systems UIO, cellular network interfaces for data (DAT), voice (TEL) and SMS text messaging (SMS). Processors and memory (RAM, ROM etc) are provided but not illustrated separately. Suitable operating systems (for example Android(R), BlackBerry OS(R), iOS(R) or Windows Phone 7(R)) are implemented in firmware and software so that various applications can run on the hardware. A GPS receiver is provided for receiving satellite signals and providing geolocation data to applications. The applications running in this case include a personal safety system application PSAPP, while other applications APP1, APP2 etc can be installed in parallel. The personal safety application communicates with a user via user I/O systems UIO, displaying information and dialog screens such as those illustrated and described already. The application communicates also with server 104 (FIG. 14) via the cellular network data interface DAT.

The main functional modules and data structures within the application PSAPP are illustrated schematically in FIG. 15. The division of the application into different modules is a matter of design choice and the division here is schematic and for the purposes of illustration only. The application can be subdivided into more or fewer modules. The modules can be implemented as separate applications, if desired. Module ADMIN is provided for administrative functions such as the registration and invitation screens. This module may also handle security functions so that unauthorised users cannot amend the data or impersonate the user. A monitor module MON is provided for displaying and updating the monitor screen (either in dependant or in guardian mode). A panic module PAN provides the function for an dependant to raise an alert when required, and for an incoming panic alert to be displayed to a guardian. Sub-modules MSG and MAP are dedicated to managing messages and map display respectively. Links are made to the main contacts database CNTCTS of the mobile phone, as required for the functions described above. These links may include ‘plug-in’ functions accessible from within a contacts application (e.g. an ‘invite as guardian’ function), without requiring to open the personal safety application itself.

Also shown within the application are replicas of the guardian list GRDLST and dependant list DEPLST that are registered for this user at the server.

The personal safety applications PSAPP running on the numerous user access terminals, together with server application SVRAPP running on server 104 provide an alert management apparatus implementing the functions set out in the introduction. The alert initiation interface provides the Panic screen and associated functions of access terminal and server. The guardian response interface provides the initial view of the Monitoring screen and invitation seen in FIG. 10a. Monitoring interface provides combined view of the map with user locations and messages. The implementation of some functions is split or distributed between the server application and the personal safety applications running on user access terminals. One way of splitting or distributing the implementation is illustrated in the embodiments described, but other ways may be possible. For example, it is envisaged that map display and message displays will be generated locally by the application on the user access terminal using programmed modules installed on the terminal. Only message data including user IDs and messages, geolocation data and the like will be exchanged over the network. In an alternative embodiment, where the application on the user terminal acts as a “dumb terminal” for the monitoring screen, all displays may be generated centrally at the server, and only display content and user interactions will be handled by the mobile terminal itself. IN another embodiment, the map display may be generated not by personal safety communication system server 104 but by a separate map server (not shown) that is located elsewhere on the network.

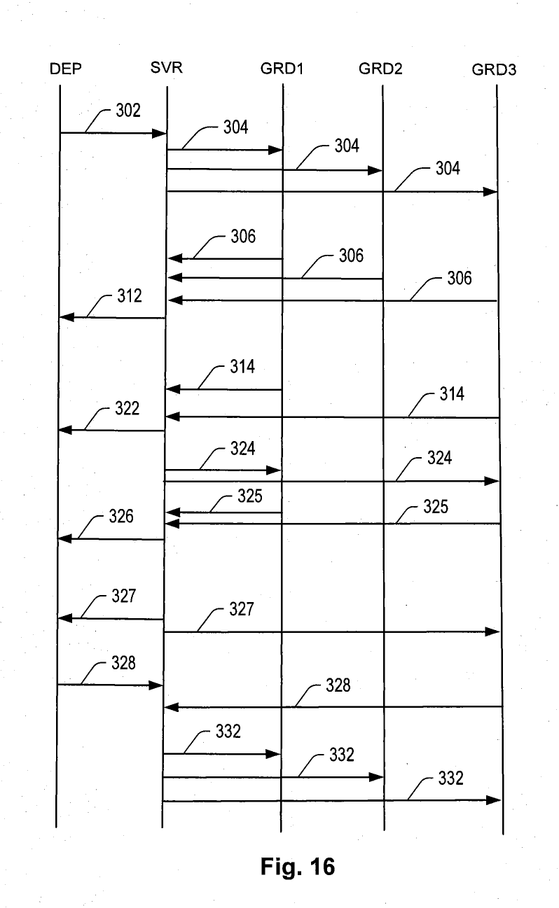

FIG. 16 is an exemplary call-flow diagram showing the sequence of communications associated with handling a panic alert in the system of FIGS. 1 to 15. Time flows from top to bottom. A dependant DEP access terminal is represented on the time while guardians GRD1, GRD2 and GRD3 have access terminals each with its own time line. The exemplary call-flow diagram is explained below by reference to the above embodiments and the related drawings. User DEP and guardians GRD1-GRD3 can be selected from any of the access terminals shown in FIG. 1. In the embodiments described herein, server 104 has its own time line and can also be conveniently referred to as server SVR.

It is understood that user DEP may have more or fewer guardians than three guardians GRD1, GRD2 and GRD3. The guardians may themselves have user DEP as a guardian, for other occasions. The minimum number of guardians of user DEP is one. However, there is no limit on the maximum number of guardians of user DEP. A list of all guardians such as GRD1-GRD3 of a dependant like user DEP can be stored in server SVR, as illustrated in FIG. 4. Alternatively, the list of guardians can be stored in another network entity, and server SVR can obtain the list of guardians from the network entity after sending a request to the network entity for the list.

After dependant DEP presses a panic button of the Home screen of the application, a message 302 is sent to server 104. Message 302 can also be referred to as a panic message.

Message 302 can include information indicating the position of user DEP (geolocation, data either in GPS location or address), identity of the user, the address of server SVR and an alert that user DEP is in need of the help from guardians of user DEP. The optional message may be included, by which the user can indicate the nature of the incident. To have the position of user DEP, the access terminal of user DEP may use the global positioning system (GPS) module in the access terminal. Alternatively, a fixed location may be pre-programmed or entered manually, if GPS location is unavailable or unreliable. In one embodiment, message 302 may also include information indicating the identity of the application, so that the date and signal sent from user DEP can be allowed to have access to a different network to which the user is not a subscriber. The application may already be logged into the server so that some information is carried implicitly by a session ID or the like.

In response to receipt of message 302, server SVR looks up the guardians list GRDLST for the user DEP and sends one or more messages 304 to each access terminal of guardians of user DEP. Message 304 can include information indicating the position of user DEP, a request for the current position of a receipt of message 304 is needed, and an alert that user DEP is in need of the help from the receipt. The optional message is sent as well.

In response to receipt of message 304, the access terminal of each guardian GRD1, GRD2 and GRD3 may send a message 306 to server SVR. Message 306 may acknowledge receipt automatically or may wait until the alert has been reviewed, and can include information indicating the position of each of guardians GRD1, GRD2 and GRD3. However, in a preferred implementation the location of each user is revealed to other users only when they consent. Therefore, the server does not necessarily need location at this stage.

In response to receipt of a message 306 from each of guardians GRD1, GRD2 and GRD3, server SVR may send a message 312 to user DEP indicating that the guardians GRD1-GRD3 have been informed of the panic alert. Before sending message 312, server SVR may wait until each of guardians GRD1-GRD3 sends the message 306. Alternatively, instead of waiting, server SVR may send a message 312 straightaway at each time when server SVR receives a message from one of guardians GRD1-GRD3. In response to receipt of message 306, the access terminal of user DEP displays update messages on the Monitoring screen the name of each of guardians GRD1-GRD3 and a message (e.g. “Guardian GRD1 has reviewed the alert”).

With the information of message 304, an access terminal of each guardian GRD1, GRD2 and GRD3 displays an alert that user DEP is in need of help. Alert sounds may be issued. The alert screen then leads the user to the Monitoring screen, where the position of user DEP and the current position of the guardian are displayed on the map. Thus, each of guardians can know from the display the proximity between user DEP and the current position of the guardian (FIG. 10a). The display of the positions of user DEP and a guardian, and the proximity between them can be shown on a map and/or expressed in words with addresses. For example, the positions of user DEP and a guardian may be expressed as pins and/or dots on a map like a Google™ map.

With the displayed information according to message 304, each of guardians GRD1-GRD3 is requested to confirm whether they can attend to help user DEP (FIG. 10a). As an example, suppose that guardians GRD1 and GRD3 confirm that they can attend to help user DEP, and the guardian GRD2 confirms that he/she is not able to help user DEP. Consequently, the access terminal of each of guardians GRD1 and GRD3 sends an “attend” message 314 to server SVR. Message 314 includes information indicating the identity of each guardian GRD1 and GRD3, the position and proximity of the guardian, and the confirmation that the guardian is coming to help user DEP immediately. Message 314 may include text information if any one of guardians GRD1 and GRD3 sends a text message to user DEP. Alternatively this messaging is performed between the applications via server 104 and need not involve email or SMS systems and applications. Therefore, the panic alert is managed entirely within the Monitoring screen of the personal safety application and at any time during the alert a text message can be sent to user DEP as a separate message.

With the message 314 sent from guardians GRD1 and GRD3, server SVR forwards the relevant information of message 314 to user DEP by sending a message 322 to user DEP. The information of the position and the identity of the guardian and the confirmation of that the guardian is coming to help user DEP immediately in message 314 is displayed on the monitoring screen of the access terminal of user DEP. In particular, the location of one or more guardians may be displayed as pins on the user DEP's map. (FIG. 10c)

In one embodiment, server SVR may provide a ‘live feed’ of all guardian's progress to user DEP by sending a request message 324 periodically to each of guardians GRD1 and GRD3 and a report message 326 to user DEP after receiving a feedback message 325 from the access terminal of each guardian GRD1 and GRD3. The access terminal of user DEP can then update the map display, indicating the progress of guardians GRD1 and GRD3.

Note that no user sees another user's position without implicit consent. The dependant consents by initiating the panic alert. Each guardian consents by indicating they will attend.

Supposing that guardian GRD3 can reach user DEP first. If the position of user DEP and the position of guardian GRD3 are the same within some tolerance, server SVR determines that GRD3 has reached user DEP. Server SVR then sends a message 327 to both user DEP and guardian GRD3, requesting user DEP and guardian GRD3 to confirm whether user DEP is safe. Message 327 can display on the monitoring screen of user DEP and guardian GRD3. After both user DEP and guardian GRD3 confirm to server SVR that user DEP is safe by sending a message 328 to server SVR, server SVR sends a message 332 to all guardians GRD1-GRD3 of user DEP. Message 332 informs each of guardians GRD1-GRD3 that user DEP is safe and the alert that user DEP is in need of help is dismissed. By requiring both to confirm they are safe, and optionally requiring a second guardian to confirm they are safe, it is avoided that the alert can be ended prematurely, for example by an attacker or other third party.

Alternatively, guardians may or may not be permitted to see the location and progress of other attending guardians. This may be selected by system design and/or by user preference.

In the communication system 100, the data transferred between user DEP and guardians GRD1-GRD3 is small, and the application installed in an access terminal can operate by transmitting data and signal through Wi-Fi, 3G or a Mobile Network signal.

The application can be designed to operate over different smart mobile phones and operate on different networks worldwide. It goes without saying that users may be in telephone contact with one another throughout the process.

The communication system 100 allows a user who can not speak over an access terminal like a mobile phone due to for example illness, injury or perhaps fear to be able to send an alert out to as many people as they have specified, and get help from them.

An effect of not limiting how many guardians user DEP can have is to increase the chance that at least one guardian can know that user DEP is in need of help and attend to help user DEP.

It may be advantageous to design the application to have a specific alert tone and vibration function for the access terminal, as that can help to alert guardians as efficiently and quickly as possible.

The application can be designed to be compatible to voice commands so that it can be activated and controlled by voice commands alone. For example, the application can be designed to incorporate the ‘Siri’ technology of Apple™ smart phone products.

If a response is not received within a predefined period (for example, five minutes) after a message is sent, sending the same message may be repeated until a response is received.

Personal safety communication system 100 enables a personal safety network for an individual person by putting that individual in immediate contact with pre-selected guardians who may for example include a husband, wife, brother, sister and a friend etc, at any given moment. It also provides peace of mind for guardians, knowing that if a loved one needs them and they would be able to contact them in an emergency. The personal safety scheme can inform all of the guardians of the position of the loved one in need of help along with their proximity to that person. Once activated, the personal safety scheme will then help to ensure that loved one's safety. The network can be set up according to the users' needs. Instead of loved ones, the network can comprise work colleagues such as field service personnel who may be able to assist one another in emergencies. Different sub-groups of guardians could be designated, according to whether a panic alert is work personal in nature. The ability to designate different sub-groups of guardians could be reserved for a premium level of subscription.

The application may also be configured to allow different levels or classes of alert to be triggered. For example a ‘social’ or ‘information’ or ‘invitation’ type of alert might be distinguished from a ‘safety’ or ‘panic’ alert. Guardians will know that response is optional. Users could then trigger social alerts with messages such as “one more player needed for football” or “spare concert ticket for tonight”. The different levels of alert can be linked automatically to different subsets of the guardians, or they maybe broadcast to all guardians. The different levels of alert may again be an optional feature, accessible on payment of premium subscription.

As examples, some typical scenarios where the application can be used and benefits of using the application are described below.

Benefits of the application:
The application gives people the opportunity to protect each other in a manner proportionate to any threat, and provides an important service to people all around the world.
The application can help to prevent a potential crime and remove a potential crime victim from a dangerous situation before a crime occurs.
Not receiving a message from a user needing help provides some reassurance that the user is ok.
There are a limited number of emergency services personnel on duty at any one time. The application could ease the burden on the emergency services.
The application has the potential for use in different countries. The application does not depend on users understanding a common language.
The application can be used as far as a user has an access terminal and can have access to a network for data communication. The application is compatible with a wide range of networks providing data connections to the internet.
The application and network can also be integrated with an established call centre so that a user can simply press a button and the call centre can then send a driver/mechanics to rescue the dependent user.

Rangers and Other ‘Special’ Users

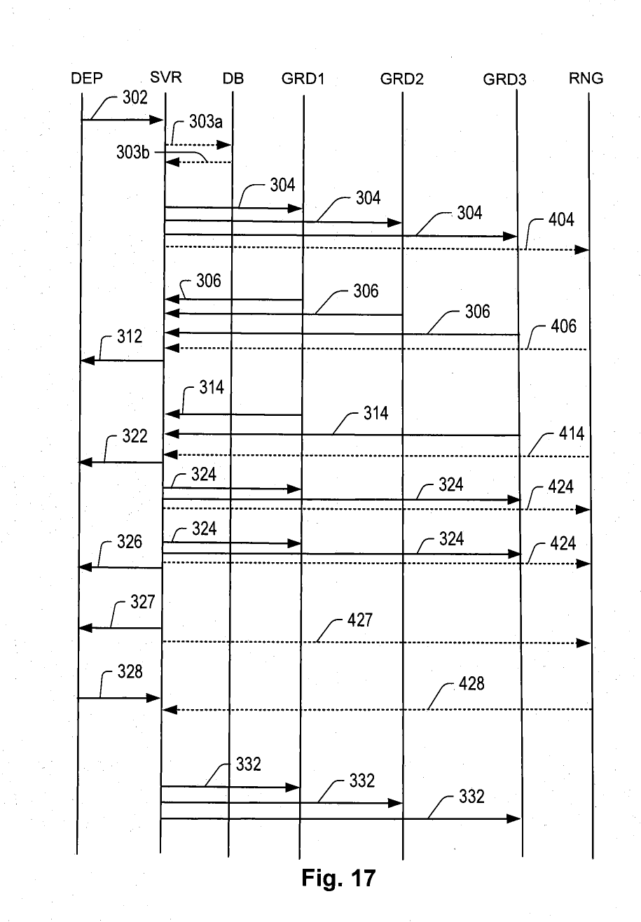

Referring to FIG. 17, in another embodiment of the present invention, communication system 100 may includes one or more access terminals of which the user is designated a “ranger” for a local area. A ranger is a user who is effectively on call for a dependant in need of help in an area of the ranger. A ranger can be pre-assessed as being capable and trustworthy for providing help in that specific area. For example, in communication system 100 the user of access terminal 118c may be a ranger for an area 124. Server 104 may have stored the user of access terminal 118c as a ranger for area 124, as indicated at RGRID in the server of FIG. 14. Alternatively, the information of ranger 118c for area 124 can be stored in the database of another network entity and server 104 can obtain the information of ranger 118c for area 124 from the network entity upon a request.

There may be a number of rangers in a given area to provide help for that area. Rangers can be volunteers, or may be employees of the service provider running the system via server 104. Users may register in their configuration CFG whether they are happy to be attended by a ranger, or only by their own guardians (or only by rangers). Ranger service may be provided on a higher subscription level than the basic service, to cover costs. Ranger data may include hours of availability and other criteria for judging whether they are suitable for a particular alert.

Having one or more rangers in an area could be very useful in a scenario where the nearest guardian is for example 20 miles away from a dependant in need of help while the ranger is only a few hundred yards away. In such a case, the ranger can attend to help the dependant earlier than the nearest guardian, and the potential danger could be dealt with quickly. The server can identify a suitable ranger from a number of rangers to be involved in a panic alert, by comparing their designated area with the location of the user initiating the panic alert. The server may alert a ranger for every alert, or only for alerts where no guardians indicate they will attend or where they are too far away to provide rapid assistance.

Alternatively, instead of designating a number of rangers in a specified area, it may be desirable to have a ranger zone based on a certain radius around a ranger user at any given time. The ranger may agree to give up their position to the server 104 at all times. In this way, an alert could be associated with the nearest ranger easily.

FIG. 17 is an exemplary call-flow diagram showing the sequence of communications associated with handling an alert message from dependant DEP to guardians GRD1-GRD3 and a ranger RNG. In this embodiment, user RNG is closest to user DEP than any one of guardians GRD1-GRD3. The call-flow diagram in this embodiment is substantially similar to an embodiment shown in FIG. 13, except those steps as indicated as dotted lines in FIG. 14 for user RNG.

If the information of rangers in the area where user DEP is positioned is stored in the database of another network entity DB, server SVR sends a request message 303a to network entity DB. Network entity DB sends back a message 303b to provide the information of rangers in this area. It is understood that if the information rangers is stored in server SVR, steps relating messages 303a and 303b may not be necessary.

It will be seen that a difference from the dependant-guardian relationship described previously is that the individual ranger is not necessarily known to and trusted by potential dependants. Rather the dependant knows and trusts only a guardian organisation. The guardian organisation in turn is responsible for knowing and trusting the individual rangers. The guardian organisation may be a service provider who employs the rangers, or a certification body who provides vetting and database maintenance. The guardian organisation may be an organisation set up specifically to provide this service, or it may be a pre-existing organisation such as the police, or a motoring organisation.

A regard to motoring organisations that operate a network of service personnel (patrol officers) on call for members, such an organisation is a potential user of a system of the type described here. In terms of system architecture and functionality, the service personnel may be regarded as a type of “ranger”, as described above. As with the rangers generally, the service can be organised and tailored in various ways. An organisation designated by a dependant user can provide rangers to respond when a member calls. Membership credentials can be stored in the server for each user, and/or may be stored in the user terminal and submitted to the server along with the panic alert. The features of the system can then be used to connect their customers directly to their drivers for messaging and location tracking.

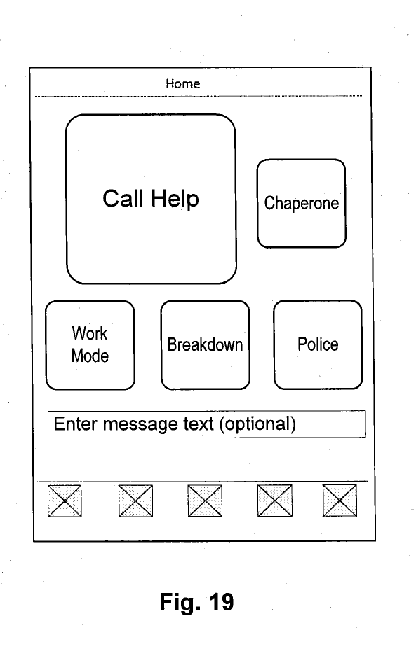

A new organisation based entirely on a system of the type described might not even need their own call centres for management of incidents and dispatch of suitable drivers. Alternatively, the system disclosed here can provide an additional interface to the existing call centres and incident management system. A user who is a member of that organisation would, after downloading and installing the personal security application, enter their own details which would also be stored on the server, for example in a ‘memberships’ field of the register REG (not shown in FIG. 14). The same data can be stared in the organisation's database. Patrol offices, can be stored in a separate section, similar to the “rangers” data shown in FIG. 14. The application software can be customised to carry branding of the organisation at a price. The organisation may supply the application (and even the mobile device) to users as a benefit of membership. Users may or may not be provided with additional functionality of nominating guardians among their friends and family. When the application does provide this functionality, the user interface is modified so that a user can trigger an alert specific to the motoring breakdown situation, this causes an alert to be generated that is communicated to the motoring organisation only, and not advertised generally among the person's guardians. An example of modified user interface will be described below with reference to FIG. 19.

When a user, for example a car driver experiencing a breakdown, needs assistance from the organisation such as a motoring organisation, then they simply press their help button (either the main help button or a separate button specific to the type of incident/organisation such as car breakdown). A message is then sent to either our server or the company server or both. How the company handles the messages and assignment of service personnel (patrol officers) is a matter of implementation. As an example, the message may be relayed out to the nearest ‘x’ drivers (lets say 5 in this case). The personnel in that case need to be visible to GPS at all times & reporting their positions to the server. Alternatively, the location of the user calling for help may be included in a message sent to all the officers or a larger group, irrespective of their current location. The nearest officer who is available to respond could then respond to attend and would be able to ‘chat’ with the user through the app to reassure them/assess the situation. On arrival the ‘driver’ and ‘customer’ both confirm that they have met and the situation is resolved. In another example; the central call centre can dispatch a specific officer according to their current location, workload and other factors, just as they would do at present.

The patrol officer or service personnel of a motoring organisation is just one example of the type of officer who may have special role similar to the general concept of “rangers”, and just one example of a type of organisation. As another example, rangers may be designated among qualified security experts around the country. These may be off duty or working on secure sites as part of their “day job”, but able to leave should an emergency occur. Access to the organisation may be free or on subscription. The business model can take different forms, as already mentioned. The service provider (which may be a company employing the rangers or a looser association) can optionally charge a (further) fee if someone were to need them.

In addition to commercial or membership organisations, the rangers role can also be assigned to emergency services such as Police Force, Fire, Mountain Rescue, as mentioned above. Where such services do not wish to integrate their user terminals in the system described here, they may nevertheless be involved through an optional ‘Escalate’ feature. At its simplest level, a button may be included in the application for calling the emergency number appropriate to wherever the user is (e.g. 911, 999, 112 according to country). At another level, a user may have initiated an alert in the manor illustrated by FIGS. 9-11. There may be no guardian available to attend, or the situation may deteriorate so that a call to the official emergency services is suddenly appropriate. An ‘escalate’ function may be included in the user's monitoring interface (either the dependant user only, or the dependant and the guardian may have this feature), paid upgrade for users.

Subject to agreement and cooperation by the service involved, the system can provide enhanced information and communication possibilities between uses and the police officers. For example, instead of the phone ringing the emergency services number is in the country in question, the app and server can send all of the already written chat along with any further chat (possibly) and the location information of the person in trouble position. If a police officer also has access to their version of the app, they may be able just to link the straight into the App (like adding a new guardian). This way they will be able to see exactly what's happening, and receive location updates, and give advice via messages or phone calls.

Additionally, the software may be provided by which police HQ can ‘push’ the data onto their nearest officers on the street so that they can see the situation unfolding in front of them on their mobile terminals, either in car or on their person. The police will also have the ability to communicate with the person in danger and their Guardians (along with other police officers who have been added to the alert). Of course this feature is not limited to just the police it could be just as easily applied to the Fire Service, Ambulance Service, Mountain Rescue, Lifeboat etc in the same way.

An application and server system with the ranger and/or motoring organisation and/or emergency service function can be provided with or without the other functions described above.

Work-Related Functions

The system can be used by businesses to provide additional personal safety, benefits for staff travelling. The system can be adapted to make this easier, for example by integrating an employee database administered by the company into the database of FIG. 14. For example, an airline may want their flight crew to be able to connect with one another while on stopovers in foreign places. Or perhaps a security company who might need the facility of officers being able to go to the aid of one guard at a particular time. We could customise the software here to carry their branding. The technology for this would work in much the same way as described above, and may be marketed as a separate App, or have a feature within the publicly available App. This enhanced feature, may allow one to toggle between work and home modes, for example. This could be the ‘Business’ or ‘Work’ version of the app may be charged for at a higher price, in light of the enhanced functionality.

At the start of a shift/job the work team could add each other to their networks as guardians, just as in the system already described. They could then call on each other in exactly the same way as described above. For added convenience, the company itself may manage the dependant-guardian relationships according to who is on which shift, or which flight crew from day to day. The company may also provide its own ranger-like personnel in different locations throughout the country or countries in which it operates.

Children and Vulnerable Adult Features

In another embodiment of the present invention, the application of the personal safety communication system 100 may have an optional module. For the care where the dependent is truly a legal dependent such a minor or a vulnerable adult, the guardian may be given additional privileges and functions, not present in the system as described above. For example, the guardian (e.g. a parent) may at push of a button be able to see the current location of a dependant (e.g. a child) on the Monitoring screen. This would be an added feature dependent on a pre-determined authorization, so the normal protections and features of the system would still function in relation to the other users. A simple “Find My Child” button could be built into the application. The configuration data CFG in the dependants list DEPLST and/or guardians list GRDLST of the registered users can specify whether a particular user is parent of another user, rather than a normal guardian.

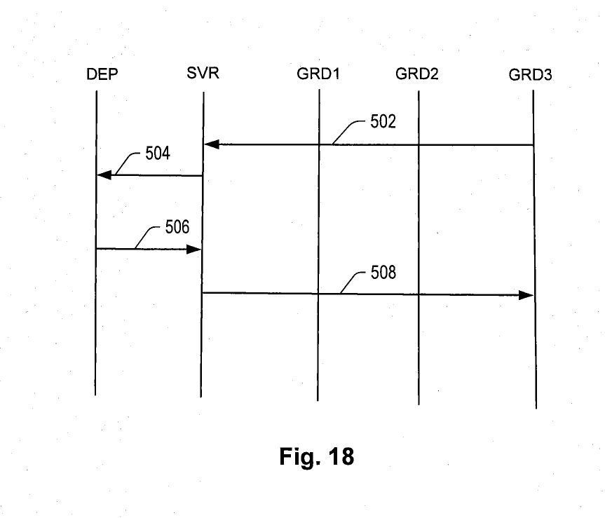

FIG. 18 is an exemplary call-flow diagram of relaying a request message from a guardian to a dependant by using above optional module according to an embodiment of the present invention. For example, after guardian GRD3 sends a message 502 to server SVR to request the position of user DEP, server SVR relay the request to user DEP by sending a message 504. With message 504, the access terminal of user DEP reports the position of user DEP to server SVR by sending a message 506. Server SVR then relays the position information of user DEP to guardian GRD3 by sending a message 508 to guardian GRD3.

This optional module of the application is independent from the main modules described in the above embodiments and does not affect the function of the above modules. Such an optional module may be provided with a simple button built in the application, and the optional module can work with a push of the button of the application.

Chaperone Function

As a further function that is neither the panic alert nor ‘fid my child’, the system may offer a ‘chaperone’ or ‘see me home’ function. By this function, a user can alert one or more guardians that they are embarking on a journey. The guardian is informed and provided with monitoring screen with real time location information. A typical situation may be a child leaving school or an adult leaving work at night to travel home. They can activate the chaperone function with a brief message such as “Leaving for home—18:15 train.” Their message and current location will then be displayed on a monitoring screen that is a modified version of the one shown in FIGS. 10a. Comparing FIG. 10a itself, instead of “Freya needs your help” a heading might be simply “Freya is travelling” along with the map and the message “Leaving for home . . . .” etc. There would be no invitation to attend, but there may be a box for entering and viewing additional text messages.

Where a person has several guardians registered among their family and friends, it is unlikely that they would want to trouble all of those users with the details of their daily journey. Therefore another difference of the chaperon function is that only selected users, designated as chaperones in the database of FIG. 14, will be alerted. The list of chaperones (which may be only one) may be used fixedly by the chaperone function. Alternatively, a chaperone for the current journey may be selected from a list of the available chaperones, or simply from a full list of registered guardians. Typically the selected chaperone will be the person to whom the user is travelling.

An advantage of the chaperone function is that it provides similar protection to the “find my child’ function, but can be applied to users who do not necessarily want their every move to be visible to the chaperone.

Additional buttons may be provided on the monitoring screen for closing the screen when the user arrives safely, or for escalating to a ‘panic’ situation, or to the emergency services in the unlikely event that the person goes missing. Again, the messages and the location and location history can be a valuable starting point for any emergency that may arise.

An application and server system with the chaperone function can be provided with or without the other functions described above.

### CONCLUSION

FIG. 19 shows a modified home screen for a system incorporating some of the additional functions described above. Compared with FIG. 3 we see the following differences:
The panic button (“Call Help” in this example) is smaller in size, to make way for some alternative kinds of call.
A “Work Mode” button is provided for switching between different subsets of guardians. For example, such a button might toggle between “Work”
“Family & Friends” modes, so that pressing the panic button will call a different set of users depending on the situation. Alternatively, there could just be provided multiple panic buttons, marked “Call Help (Work)”, “Call Help (Friends)”, each triggering an alert to the appropriate subset of guardians and/or rangers. The work-related buttons may be branded for quick identification.
A “Breakdown” button is provided for calling specifically on a service provider such as a motoring organisation, without troubling any of the guardians. The button may be branded; the user may subscribe to several organisations, and several buttons may be provided for easy access.
An escalate button (“Police” in this example) is provided, for calling the emergency services in the button
A “Chaperone” button is provided, for use in activating the chaperone function as described above. As already mentioned, this may trigger an alert to a predetermined one or two chaperones, or it may lead to a dialogue through which the user can selected an appropriate chaperone for the journey in question.

The application may be provided with a synchronization module. Such a synchronization module is configured to synchronize via server 104 a number of different access terminals of an individual user. Therefore, the user can receive an alert via his TV and when he gets into his car similar information relating to an alert as described in the above embodiments can be synchronized by this module into mobile access terminal, for example his mobile phone or even his satellite navigation device in the car.

Buttons labelled with text in the example can equally be labelled with graphics or images such as photos or logos.

Various aspects or features described herein can be implemented as a method, apparatus, using standard programming and/or engineering techniques. The invention may be delivered in the form of a computer program accessible from a computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. The application can be delivered as a downloaded file from a web server, including the well known “application store” sites or a dedicated website.

The descriptions above are intended to be illustrative, not limiting. Thus it will be apparent to one skilled in the art that various modifications may be made to the invention as described without departing from the spirit and scope of the invention.

1. A personal safety communications system comprising a plurality of user terminals belonging to a plurality of individual users and being interconnected via one or more networks, the system including the user terminals including an alert management apparatus, the alert management apparatus comprising a relationship database storing a set of dependant-guardian relationships among users of said user terminals such that one or more users can be designated as guardians of another user, including the possibility for users to be guardians of one another;
an alert initiation interface by which a first user having one or more designated guardians can use their user terminal to initiate an alert situation and to indicate their location;
a guardian response interface responsive to initiation of said alert situation for providing to users who are guardians of the user via their user terminals, notification of the alert including an indication of the location of the first user and for receiving from the guardian an indication whether they will attend or not attend to assist the first user and in the event that they will attend for receiving from the guardian's user terminal an indication of the guardian's location; and
a situation monitoring interface for informing the first user of the identity and location of one or more guardians who have indicated they will attend.

2. A system as claimed in claim 1 wherein said alert management apparatus is formed by said user terminals operating in conjunction with one or more server devices connected to the network, the server device(s) being operable for the exchange of data messages with each user terminal.

3. A system as claimed in claim 2 wherein said relationship database is maintained by the server, wherein the user terminal of the first user is arranged to send an alert initiation message to said server, and the server is arranged to send a guardian response invitation to guardians who are identified in the relationship database as guardians of the first user.

4. A system as claimed in claim 1 wherein the exchange of data messages communication between said user terminals and server is independent of email and SMS applications to which said user terminals and/or the server may also have access.

5. A system as claimed in claim 1 wherein said situation monitoring interface includes a map display showing the relative locations of the dependant and one or more attending guardians.

6. A system as claimed in claim 5 wherein said situation monitoring interface is arranged to update said map display automatically as the locations of the users change over time.

7. A system as claimed in claim 5 wherein said situation monitoring interface additionally includes a message entry and display function by which users can submit messages for one another to read without switching to another application.

8. A system as claimed in claim 7 wherein said message display is viewable simultaneously with said map display and displays a combination of messages associated with the alert situation, the messages including messages containing content generated explicitly by other users and messages generated automatically by the alert management apparatus in response to events in the operation of the alert management apparatus and the various interfaces thereof.

9. A system as claimed in claim 1 wherein said alert management apparatus provides participating users with an alert terminating interface and imposes an alert terminating protocol, and by means of which an alert can be terminated only in the event that alert termination messages are received from a predetermined combination of user terminals, not from the dependant's terminal alone.

10. A system as claimed in claim 1 wherein functions of said alert management apparatus to be performed by said user terminals are implemented by installing a personal safety application on a multi-purpose user terminal device, the user terminal device comprising a programmable mobile communication device having an operating system, user interface functions, communication functions and optionally geolocation functions.

11. A system as claimed in claim 1 further comprising a relationship management interface by which a user can invite one or more other users to become their guardian and/or dependant, the relationship management system updating said database with a new relationship in response to a recipient accepting such an invitation.

12. A system as claimed in claim 11 wherein said alert management apparatus is implemented in part by a personal safety application installed on a user terminal device, and wherein for inviting a user to become guardian or dependant who has not yet installed said personal safety application, the relationship management interface is arranged to issue an invitation to download and install the application using an email or SMS applications to which said user terminal device has access.

13. A system as claimed in claim 1 wherein one or more other users are designated rangers, the alert management apparatus including a facility to invite such a ranger as a guardian in response to an alert from the first user with a location corresponding to a ranger's geographic area.

14. A system as claimed in claim 1 wherein the relationship database is configured so that for at least a subset of users, more than one set of guardians can be designated, and wherein said alert initiation interface is arranged to identify directly or indirectly which set of guardians should be invited in response to a current alert initiation message.

15. A user terminal configured to implement the user terminal functions of the alert management system in a personal safety communication system as claimed in claim 1.

16. A computer program product for configuring a programmable user terminal device to implement the user terminal functions of the alert management apparatus in a personal safety communication system as claimed in claim 1.

17. A server device configured to perform server functions of the alert management apparatus in a personal safety communication system as claimed in claim 1.

18. A computer program product for configuring a programmable computer server to implement server functions the alert management apparatus in a personal safety communication system as claimed in claim 1.
